(19) United States
(12) Patent Application Publication
(10) Pub. No.: US 2020/0219066 A1
(43) Pub. Date: Jul. 9, 2020

(54) Mechanisms for Improving the Visibility of Time Spent in Conferences and Eliminating Less Useful Meetings

(71) Applicant: Avaya Inc., Santa Clara, CA (US)

(72) Inventors: Lin Lin, Tottenham (CA); Ping Lin, Tottenham (CA)

(21) Appl. No.: 16/242,193

(22) Filed: Jan. 8, 2019

(51) Int. Cl. G06Q 10/10; H04L 12/18

(52) U.S. Cl. CPC G06Q 10/1095; H04L 12/1831; H04L 12/1818

(57) ABSTRACT

An electronic conferencing system is provided to enable nodes on a communication network to be aware of meetings, utilizing the conferencing system, that will or will not be held. Meetings utilizing conferencing systems are scheduled, and initially marked as tentative. If a meeting receives an endorsement, such as detecting a document being uploaded, an agenda being provided, an invitee having interest in a particular topic, etc., the meeting may be identified as confirmed. If a meeting fails to receive an endorsement, such as before the occurrence of a deadline, the meeting is automatically canceled. If the meeting has been confirmed, then the conferencing system may allocate resources to facilitate the occurrence of the meeting.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for communication management and particularly to state management notifications.

### BACKGROUND

Meetings can take up a significant portion of working hours. Many are held on conference bridges which tie up additional resources. Meetings may be scheduled to begin at a specific time and/or duration. However, one or more participants may connect early, late, or not at all. Similarly, participants may attend only to discover the meeting has no purpose.

### SUMMARY

These and other needs are addressed by the various embodiments and configurations of the present invention. The present invention can provide a number of advantages depending on the particular configuration. These and other advantages will be apparent from the disclosure of the invention(s) contained herein.

Audio, video, communications may comprise document, media and/or screen sharing applications (bridges or electronic conferences) and are available to allow users to utilize networked devices to conduct meetings and share information without requiring the users to be physically co-located. The bridges often capture information on when meetings actually start and end, as well as on who connected, what device (or device type) they used to connect, etc. Bridges are a source of ground truth that can be utilized by systems, such as calendar and presence systems, to provide better visibility into the time spent in meetings and enable other functionality.

When a lot of meetings use conference bridges, the latter can be used to provide enhanced visibility into time spent in meetings at the immediate as well as over longer time scales—visibility that can be coupled to mechanisms in a feedback loop to have fewer but more useful meetings.

In certain embodiments, a calendar system incorporates mechanisms that support more useful meetings which compete for timeslots against less useful ones and reduce or eliminate unnecessary ones. Visibility into the true cost of meetings can motivate the use of such mechanisms and be used to monitor their effects.

What happens in reality is often quite different from what is on an individual's calendar. A person might skip some meetings, meetings start late, take much longer, etc. This impacts the reliability of calendar analytics and presence state.

Recurring meetings are often booked to claim a particular timeslot. Many occurrences are perfunctory affairs that either serve no purpose or no purpose for having the meeting and should be cancelled. This requires a vigilance and fastidiousness that few are willing to do or maintain. Calendars often become tiled with meetings that may not be real, while real meetings struggle to find time.

In certain embodiments, a conference bridge feeds the actual start and end times of meetings back to the calendar system. Calendars can display this information; this would be especially useful for recurring meetings, where it could be presented as average duration, minimum/maximum duration, or perhaps a graph of duration over time. This sort of visibility can be used to adjust the length of meeting slots, and even inform the placement of other meetings or activities: scheduling something immediately after a meeting that always runs over does not work very well. It is also enlightening to be able to calculate the actual cost of a recurring meeting in people-hours over time.

Presence systems typically use calendar data to show when someone is in a meeting and/or other attributes (e.g., away, do not disturb, on a call, etc.). Incorporating information from conference bridges improves the quality of presence reporting. When a meeting runs over, presence state can reflect that rather than transition to available. If a meeting finishes early, presence state can transition to available before the scheduled end time.

In another embodiment, scheduling a recurring meeting enables the meeting to be made tentative: each occurrence would be automatically cancelled if not confirmed by a suitable action before the deadline set for each meeting. Alternatively, if a meeting is frequently cancelled, rather than repeatedly sending cancellations, attendance might be better served if a confirmation is sent when it will be held. Calendars would display unconfirmed meetings in a visually different way than confirmed ones (e.g., lighter shade). This is helpful when scheduling: although the calendar may appear full, it may hold a lot of unconfirmed meetings.

A tentative option can apply to one-shot meetings as well.

The following are some ways to confirm that a meeting should take place:

The caller of the meeting indicates that it will occur.

The caller of the meeting sets an agenda.

The caller of the meeting uploads a slide deck or other document.

At least one invitee clicks a button on the meeting in their calendar to indicate that he/she will have something to discuss.

N invitees click a button on the meeting to indicate that they can attend, e.g. N=(# of invitees+1)>>1 for quorum.

A designated subset of invitees considered core all click a button on the meeting to indicate that they can attend.

Invitees may be allowed to change their vote right up to the confirmation deadline.

Several meetings might be vying for the same time slot. If they are all unconfirmed, each invitee may decide which is the most worthwhile and vote accordingly. At the end, meetings that get confirmed all got the required number or list of attendees.

In one embodiment, a system is disclosed, comprising: a microprocessor; a network interface; and a data storage; and wherein the microprocessor: receives a request for a meeting comprising invitees, wherein the invitees comprise at least two invitees and a conferencing resource enabling electronic communications between each of the invitees utilizing an associated networked device configured to be networked via the conferencing resource; processes the request comprising causing a record to be created associated with the meeting, the record identifying each invitee and having an occurrence state initially set as tentative; at a subsequent time, after the creation of the record, receiving an endorsement and, in response to receiving the endorsement, changing the occurrence state to confirmed; scheduling at least the conferencing resource for meetings having an occurrence state of confirmed; and omitting scheduling any resource for meetings having an occurrence state of tentative.

In another embodiment, a method of operating an electronic conferencing system is disclosed comprising at least one microprocessor, comprising: receiving a request for a meeting comprising invitees, wherein the invitees comprise at least two invitees and a conferencing resource enabling electronic communications between each of the invitees utilizing an associated networked device configured to be networked via the conferencing resource; processing the request comprising causing a record to be created associated with the meeting, the record identifying each invitee and having an occurrence state initially set as tentative; at a subsequent time, after the creation of the record, receiving an endorsement and, in response to receiving the endorsement, changing the occurrence state to confirmed; scheduling at least the conferencing resource for meetings having an occurrence state of confirmed; and omitting scheduling any resource for meetings having an occurrence state of tentative.

In another embodiment, a computer-readable medium is disclosed having instructions thereon that, when read by a microprocessor, cause the microprocessor to perform: receiving a request for a meeting comprising invitees, wherein the invitees comprise at least two invitees and a conferencing resource enabling electronic communications between each of the invitees utilizing an associated networked device configured to be networked via the conferencing resource; processing the request comprising causing a record to be created associated with the meeting, the record identifying each invitee and having an occurrence state initially set as tentative; at a subsequent time, after the creation of the record, receiving an endorsement and, in response to receiving the endorsement, changing the occurrence state to confirmed; scheduling at least the conferencing resource for meetings having an occurrence state of confirmed; and omitting scheduling any resource for meetings having an occurrence state of tentative.

Unless expressly stated otherwise (e.g., “in-person meeting”), the term “meeting” refers to at least two parties each utilizing a respective at least two associated communication nodes communicating, via an electronic (e.g., electrical, packet switched, fiber optic, radio frequency, etc.) communications network, to conduct an electronic conference.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a data structure in accordance with embodiments of the present disclosure;

FIG. 3 depicts an overview interaction diagram in accordance with embodiments of the present disclosure; and

FIG. 4 depicts a process in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

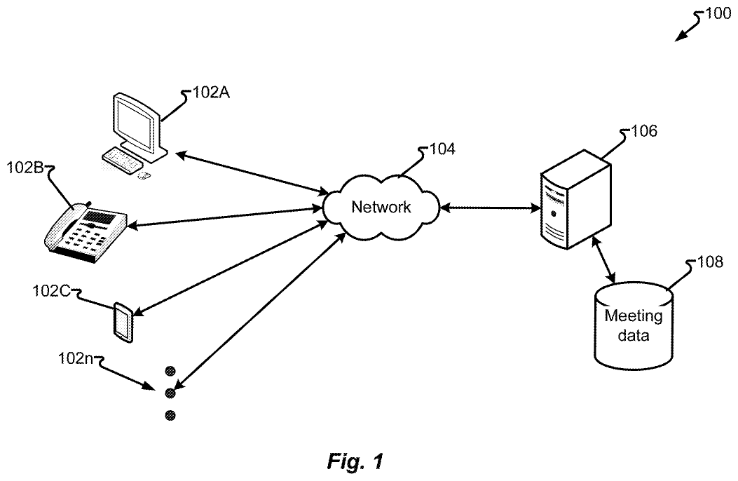

FIG. 1 depicts system 100 in accordance with embodiments of the present disclosure. In one embodiment a plurality of communication nodes 102 are configured to engage in an electronic conference via network 104. Communication nodes 102 may be homogeneous (e.g., all personal computers 102A, all voice-only telephones 102B, all mobile devices 102C, etc.) or heterogeneous, such as a mixture of two more personal computers 102A, all voice-only telephones 102B, all mobile devices 102C, and/or other devices 102n. Each communication node 102 comprises a microprocessor, input-output components (e.g., one or more microphone, speaker, display, camera, touchscreen, etc.), memory, and/or other components to enable a user of any one communication node 102 to communicate with another user of another communication node 102 via network 104. Network 104 may be a telephony network (plain old telephone system (POTS), session initiation protocol (SIP), voice over IP (VoIP), cellular telephony, etc.), packet switched network (Internet, WiFi, ethernet, etc.), or combinations thereof (each being an embodiment of an “electronic conference” or “meeting”) and/or other communication technology to enable communication nodes 102 to conduct communications in voice, video, and data, such as to share media, documents, screen-share, virtual reality, etc. or a combination thereof.

Server 106 comprises a network interface, at least one microprocessor, and data storage comprising one or more of electronic memory, fixed media, removable media, “cloud” storage accessible to the microprocessor therein or any other combination to allow the microprocessor therein to store and retrieve data and/or instructions for the execution of the microprocessor. Meeting data 108 is illustrated as external to server 106, however, in other embodiments meeting data 108 may be embodied as internal to server 106, one or more communication nodes 102, and/or other accessible data storage to server 106. In another embodiment, server 106 may be embodied, entirely or partially, as one or more communication nodes 102.

Server 106 may preform one or more of scheduling a meeting, sending/managing state change notifications to invitees, receiving documents for sharing, floor control, hosting, and/or other conference service. Server 106 may also access (read and/or write) meeting data to meeting data 108, such as to record meetings that created, whether or not they were canceled, rescheduled, scheduled start/end time, actual start/end time, attendees, attendees actual/start time, subject matter, agenda, title, etc. Server 106 may provide some or all content to one or more communication nodes 102 and/or receive content from one or more communication nodes 102 for recording meeting data 108. It should be appreciated that meeting data 108 and/or other data storage, may maintain other data as may be utilized for electronic conferencing and/or other purpose.

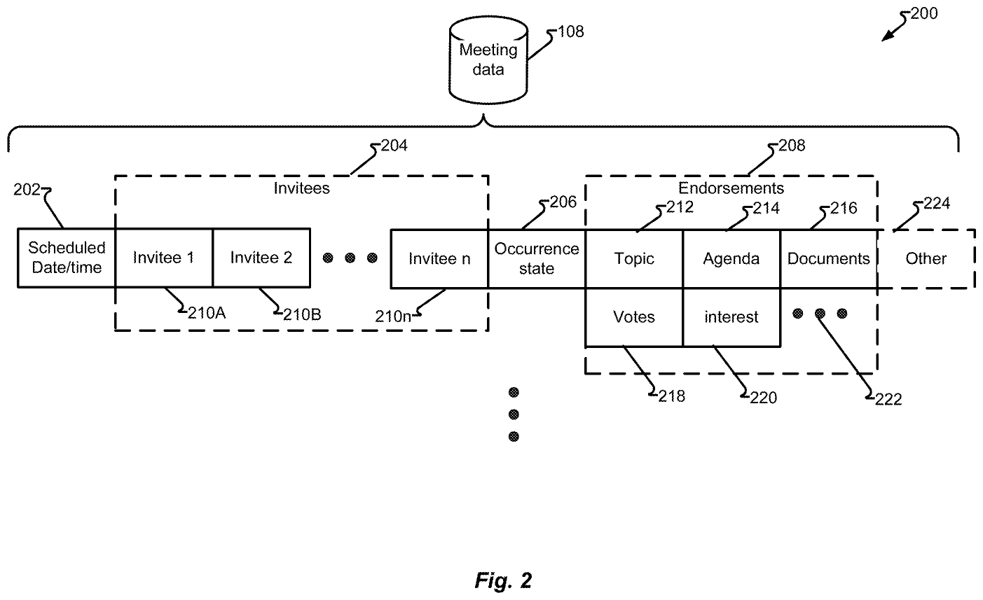

FIG. 2 depicts data structure 200 in accordance with embodiments of the present disclosure. In one embodiment, meeting data 108 comprises one or more data structures 200 comprising fields for a meeting and may further comprise scheduled data/time field 202, which may comprise a single entry (e.g., start time) or a data structure (e.g., start time, duration, end time, etc.) and/or other indicia of when the meeting will be held. Data structure 200 may further comprises invitee block 204, endorsement block 208, and occurrence state 206. Other field 224 may be utilized as a matter of design or implementation choice, such as to include a textual description of the meeting, subject matter, connection instructions, any special instructions, and/or other information associated with a particular meeting.

Meetings, as embodied herein, comprise two or more invitees, accordingly, invitee block 204 comprises, invitee 1 field 210A, invitee 2 field 210B, and optionally “n” additional invitees (invitee field n 210n). It should also be appreciated that one or more invitees 210 may have an associated attendance record (not shown), such as “accepted,” “rejected,” “tentative,” etc. for a particular meeting or instance of a recurring meeting. A meeting may have an initial value of occurrence state 206, such as “tentative,” “pending,” “proposed,” etc. Endorsement block 208 comprises one or more fields identifying any endorsement (e.g., at least one invitee 210 endorsing conducting the meeting), specific fields (e.g., fields 212-220) may also be used for specific types of endorsements and/or identification of the particular invitee 210 providing the endorsement. For example, topic 212 may be provided by an invitee to identify a particular topic of discussion, similarly, agenda 214 may identify a number of issues or topics of discussion. If one or more invitees 210 uploads a document, the document itself and/or indicia of the document may be provided in document field 216 and indicate an endorsement. A number of invitees 210 may vote on whether the meeting should or should not be held, the votes may be maintained in vote field 218. Similarly, to a vote, interest field 220 may maintain indicia of any one or more invitees 210 expressing a desire, or interest, in having the meeting. Other endorsements 222 may be provided as a matter of design choice, such as for particular criteria indicating that a meeting should or should not be held.

In another embodiment, meeting data 108 may comprise historical information on past meetings, such as in-person meetings and/or meetings, and/or other information such as salary data, productivity data, etc. The historical data may indicate a cost associated with meetings and, such as in other endorsements 222 may indicate a cost associated with a particular meeting associated with data structure 200. The cost may be financial (e.g., hourly wages of attendees divided by the estimated duration of the meeting), productivity (e.g., number of items not produced, work tasks not performed, etc., due to the invitees attending the meeting). In some embodiments, other field 224 may maintain cost information associated with a particular meeting.

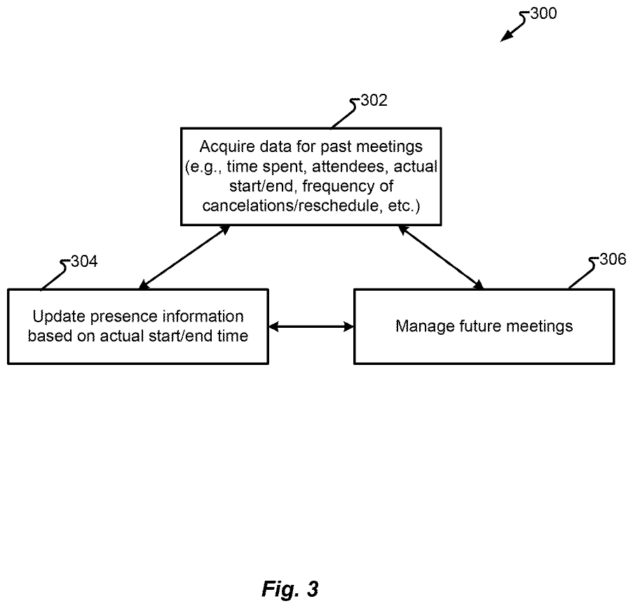

FIG. 3 depicts overview interaction diagram 300 in accordance with embodiments of the present disclosure. In one embodiment, a microprocessor, such as utilized by server 106 acquires data for past meetings in block 302, updates presence information for attendees and/or resources in block 304, and/or manages future meetings in block 306. It should be appreciated that in certain embodiments, meetings data may include in-person meetings in addition to the electronic conferences, and in still other embodiments, meetings data comprises meetings having a mixture of in-person and meetings (e.g., a number of attendees sharing a conference room or other physical location serving as a single communication node 102 to other attendees participating at other physical locations on their respective communication nodes 102).

In one embodiment, block 302 provides a source of data for reports and/or scheduling decisions for future meetings. For example, payroll, connectivity, lost production due to meeting attendance, and other costs of associated having a meeting may be provided for manual consideration and/or automatic execution of a rule (e.g., costs greater than a threshold value has to be approved by a vice president, etc.). Additionally or alternatively, block 302 provides history associated with past meetings. While, the time an in-person meeting begins may be subject to recording errors, forgetfulness, or even fabrications the time an electronic conference begins can be precisely determined and recorded. As communication nodes 102 connect to a conference server, such as server 106, their precise time of connection/disconnection may be recorded automatically.

In another embodiment, block 302 maintains a history of cancelations, rescheduling, or postponements. For example, a meeting entitled, “weekly staff meeting,” may be scheduled weekly, but is frequently canceled. Cancelations may occur for reasons such as a lack of relevant subject matter to discuss, absence of critical attendees, holidays, other higher priority tasks, etc. Additionally or alternatively, meetings may be observed to start later (or earlier) than scheduled.

Block 306 may then create records for meetings that are initially identified as tentative and, unless endorsed by a previously determined deadline, canceled. The deadline may be a relevant time before a meeting is scheduled to begin. For example, if all invitees are readily available to join a meeting and have nothing to prepare in advance, the deadline may be the start time of the meeting. In another example, invitees require time to prepare, configure their communication node 102, accept other meetings or tasks, or perform other tasks that would be a wasted opportunity if they prepared for the meeting only to discover it was canceled and, accordingly, the deadline may be the period of time that is determined to be used, at least in part, for preparing for the meeting, preparing or conducting other activities, etc. In another embodiment, block 306 may automatically alter the timing of a meeting. For example, a repeating meeting may be scheduled to start at 9:00 AM every Wednesday, but historic records of meeting data 108 indicate that the actual start time is 9:15 AM and, therefore, override the provided start time (e.g., 9:00 AM) with the determine start time (e.g., 9:15 AM). Similarly, a meeting scheduled for every Thursday may routinely be scheduled for the following Tuesday and, as a result, automatically have the meeting date moved to Tuesdays.

Block 304 may be executed by a microprocessor of server 106 and/or other device providing presence information. Block 304 may be automatically updated to reflect predicted start/end times of meetings. Continuing the example above, invitees may have 9:00 AM to 10:00 AM blocked off every Wednesday for the particular meeting. However, if the actual start time is 9:15 AM, the time between 9:00 AM and 9:15 AM may be identified as “free,” “available,” “meeting preparation,” or other state other than “in a meeting.” Should a meeting be canceled, block 304 may then update the presence information to cause the invitee's state to indicate that they are no longer in the, now cancelled, meeting. Additionally or alternatively, block 304 may receive presence information and/or other endorsements (e.g., endorsements 208). For example, a tentative meeting may be endorsed by a particular invitee indicating “attending” and, as a result, cause block 302 to indicate the meeting will be held or, at least, support for holding the meeting. An invitee may also indicate that they will attend a meeting at a scheduled time (e.g., 9:00 AM) and, as a result, the automatic rescheduling to a historic actual start time (e.g., 9:15 AM) omitted.

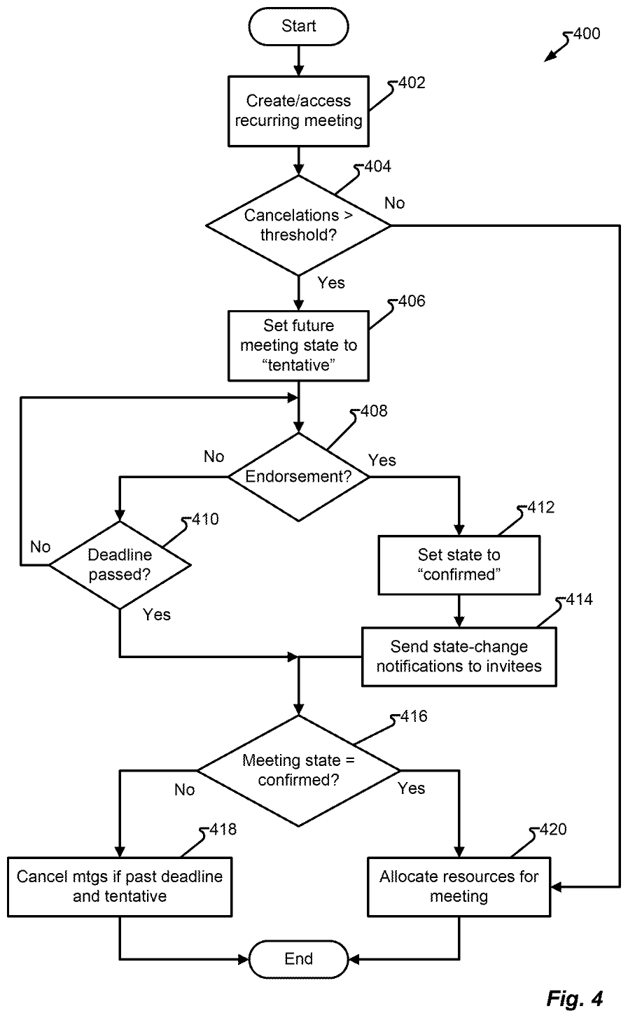

FIG. 4 depicts process 400 in accordance with embodiments of the present disclosure. In one embodiment, step 402 creates a new meeting and, in another embodiment, step 402 accesses a previously scheduled meeting, such as by a microprocessor of server 106 and/or communication node 102 accessing meeting data 108 comprising one or more record 200 to retrieve information, when the meeting has previously been scheduled. A recurring meeting may comprise a plurality of records 200 or a single record 200 having a recurrence information, such as in other field 224.

Next, test 404 determines if the number of cancelations of instances of a recurring meeting is greater than a threshold amount. In one embodiment, this may be a ratio of canceled/non-canceled meetings and in another embodiment it may be at least one immediately preceding meeting, in another embodiment, the number of remaining meetings in a series is utilized, and in another embodiment, it is user determined, such as to indicate a priority. For example, a series of meetings to discuss a mission critical aspect of a project may have a field in record 200 that causes the meeting to never be canceled regardless of any prior cancelations, another meeting may have occurred regularly (e.g., weekly, bi-weekly, etc.) for the last six months and with only two meetings remaining, will not be canceled. However, other meetings may have cancelations at or above a threshold amount. A weekly staff meeting that has been canceled for the last five weeks may have a high probability of being canceled again. Accordingly, test 404 determines if the number of prior cancelations, and or other criterion as described herein, is beyond a threshold and, if not, test 404 is determined in the negative and may proceed, such as to the allocation of resources in step 420. If test 404 is determined in the affirmative, step 406 may then be executed. Additionally or alternatively, step 404 may determine if a meeting is routinely started at a different time/date than what is scheduled and thereby causing the original meeting time/date to be “tentative” and automatically adjusted meeting time/date to be provided.

Step 406 sets the meeting state, such as occurrence state 206, to tentative. Invitees 210 may then execute a calendaring application on their respective communication devices 102 and/or other devices and be presented with at least the next occurrence of the meeting is tentative. This may be indicated by a color, shading, font, shape, and/or other indicia to provide a visual cue as to the meeting being tentative and thereby provide one or more invitees 210 with the opportunity to plan their activities with the knowledge that the meeting may not occur.

Next test 408 determines if an endorsement has been received for a particular instance of a meeting, such as by receiving a vote, an uploaded agenda, document, and/or other endorsement that the meeting should or will be held (see, FIG. 2 endorsement block 208). If test 408 is determined in the negative, test 410 may execute to determine if a deadline to receive the endorsement has passed. If test 410 is determined in the negative, then process 400 may loop back to test 408. If test 408 is determined in the affirmative, step 412 may set the occurrence state to confirmed and cause notification messages to be provided in step 414. As a result of the notification messages (which may be a state change on remote data structure comprising meeting states), a calendaring client for invitees 210 may change to provide indicia for the meeting that is associated with occurrence (e.g., change font, color, shape, etc.) and/or send an email, text message, voice message, etc. to the associated communication device 102 and/or other calendaring device or application utilized by invitees 210.

Test 416 determines if the state of the meeting is confirmed and, if true, step 420 allocates resources. Resources may comprise time on an electronic conferencing system, such as to allocate connections that may be otherwise used for other purposes, request connection information (e.g., conference identifier, call-in number, passcode, etc.) to provide such connection information to invitees 210, access documents (e.g., cache stored documents to be discussed, etc.). However, if test 416 is determined in the negative, step 418 may cancel the meeting and send notifications to communication devices 102 and/or other calendaring devices and/or applications to free up the space on invitee 210 calendar or to release any allocated resources.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose microprocessor (e.g., GPU, CPU), or logic circuits programmed with the instructions to perform the methods (e.g., FPGA). In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
a microprocessor;
a network interface; and
a data storage; and
wherein the microprocessor:
receives a request for a meeting comprising invitees, wherein the invitees comprise at least two invitees and a conferencing resource enabling electronic communications between each of the invitees utilizing an associated networked device configured to be networked via the conferencing resource;
processes the request comprising causing a record to be created associated with the meeting, the record identifying each invitee and having an occurrence state initially set as tentative;
at a subsequent time, after the creation of the record, receiving an endorsement and, in response to receiving the endorsement, changing the occurrence state to confirmed;
scheduling at least the conferencing resource for meetings having an occurrence state of confirmed; and
omitting scheduling any resource for meetings having an occurrence state of tentative.

2. The system of claim 1, wherein the microprocessor further creates the record to comprise a deadline and in response to receiving the endorsement, at the subsequent time being a time after the deadline has passed, omitting changing the occurrence state to confirmed.

3. The system of claim 2, wherein the microprocessor, at the subsequent time being a time after the deadline has passed, cancels the meeting; and
formats and transmits messaging cancelling the meeting to the network devices.

4. The system of claim 1, wherein the microprocessor further creates the record to comprise a deadline and in response to receiving the endorsement, at the subsequent time being a time prior to the passing of the deadline, changing the occurrence state to confirmed.

5. The system of claim 1, wherein the system comprises at least one of the networked devices.

6. The system of claim 1, wherein at least one of the network devices presents the record having a distinguishing indicia, the distinguishing indicia differentiating whether the record is associated with a meeting that is tentative or confirmed.

7. The system of claim 1, wherein the endorsement comprises receiving a content associated with the meeting.

8. The system of claim 7, wherein the content comprises one or more of at least one invitee indicating attendance, a document is uploaded that is associated with the meeting, an agenda is provided that is associated with the meeting, an agenda topic is identified for discussion by a particular invitee, the number of invitees confirming their attendance is above, or a previously determined threshold.

9. The system of claim 1, wherein the meeting comprises a plurality of meetings, having a common topic and each meeting having one of a series of starting dates.

10. The system of claim 9, wherein the record comprises a plurality of records for each of the corresponding plurality of meetings.

11. The system of claim 1, wherein an endorsement for one of the plurality of meetings is provided by the microprocessor receiving indicia of an immediately preceding meeting of the one of the plurality of meetings, having occurred without being canceled.

12. The system of claim 1, wherein upon the microprocessor changing the value of the occurrence state for the record, causes a notification message thereof to be generated and transmitted to each invitee associated with the record.

13. The system of claim 1, wherein the microprocessor, upon receiving an endorsement for a record associated with a conflicting meeting, changes the occurrence state to canceled.

14. A method of operating an electronic conferencing system comprising at least one microprocessor, comprising:
receiving a request for a meeting comprising invitees, wherein the invitees comprise at least two invitees and a conferencing resource enabling electronic communications between each of the invitees utilizing an associated networked device configured to be networked via the conferencing resource;
processing the request comprising causing a record to be created associated with the meeting, the record identifying each invitee and having an occurrence state initially set as tentative;
at a subsequent time, after the creation of the record, receiving an endorsement and, in response to receiving the endorsement, changing the occurrence state to confirmed;
scheduling at least the conferencing resource for meetings having an occurrence state of confirmed; and
omitting scheduling any resource for meetings having an occurrence state of tentative.

15. The method of claim 14, further comprising creating the record to comprise a deadline and in response to receiving the endorsement, at the subsequent time being a time after the deadline has passed, omitting changing the occurrence state to confirmed.

16. The method of claim 1, further comprising creating the record to comprise a deadline and in response to receiving the endorsement, at the subsequent time being a time prior to the passing of the deadline, changing the occurrence state to confirmed.

17. The method of claim 14, wherein the endorsement comprises receiving a content associated with the meeting.

18. The method of claim 17, wherein the content comprises one or more of at least one invitee indicating attendance, a document is uploaded that is associated with the meeting, an agenda is provided that is associated with the meeting, an agenda topic is identified for discussion by a particular invitee, the number of invitees confirming their attendance is above, or a previously determined threshold.

19. The method of claim 14, further comprising automatically allocating the resource at the occurrence of the meeting.

20. A computer-readable medium having instructions thereon that, when read by a microprocessor, cause the microprocessor to perform:
receiving a request for a meeting comprising invitees, wherein the invitees comprise at least two invitees and a conferencing resource enabling electronic communications between each of the invitees utilizing an associated networked device configured to be networked via the conferencing resource;
processing the request comprising causing a record to be created associated with the meeting, the record identifying each invitee and having an occurrence state initially set as tentative;
at a subsequent time, after the creation of the record, receiving an endorsement and, in response to receiving the endorsement, changing the occurrence state to confirmed;
scheduling at least the conferencing resource for meetings having an occurrence state of confirmed; and
omitting scheduling any resource for meetings having an occurrence state of tentative.
